(19) United States
(12) Patent Application Publication
(10) Pub. No.: US 2008/0207271 A1
(43) Pub. Date: Aug. 28, 2008

(54) METHODS AND DEVICES FOR ABRIDGED CONTACT LIST CREATION BASED ON COMMUNICATION HISTORY

(75) Inventors: VLADISLAV V. KRUTIK, SAN DIEGO, CA (US); MAZEN S. LABBAN, SAN DIEGO, CA (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/679,568

(22) Filed: Feb. 27, 2007

(51) Int. Cl. H04M 1/00

(52) U.S. Cl. 455/566; 455/550.1

(57) ABSTRACT

Disclosed are methods and mobile communication devices for providing a history of communications with a contact according to at least one of a plurality of communication types. The communication types can include, for example, outgoing and incoming telephone calls, messaging service messages and voicemail box messages. A disclosed method can include recording an indicator of a communication in a history of communications associated in a contact list with the contact of the contact list according to the communication type, and displaying the history of communications with the contact according to at least one of the plurality of communication types. A particular contact group of contacts based on a frequency of communication or another criterion with the contacts can be displayed, so that different types of abridged and/or speed dialing lists can be generated and displayed. A list can be dynamic, changing with, for example, additional communication information and different indicators.

### FIELD

Disclosed are methods and mobile communication devices for providing a history of communications, and more particularly for providing a history of communications with a contact according to at least one of a plurality of communication types.

### BACKGROUND

The makers of mobile communication devices, including those of cellular telephones, are increasingly adding functionality to their devices. For example, cellular telephones include features such as still and video cameras, video streaming and two-way video calling, email functionality, Internet browsers, music players, FM radios with stereo audio, and organizers. Mobile commerce, facilitated generally by mobile phones, can include services such as banking, payment, and ticketing. Cellular telephones in particular are becoming more than simply mobile communication devices. They are evolving into powerful tools for information management.

Mobile users are increasingly spending time engaged by their mobile communication devices. Oftentimes, users will communicate with the same persons or entities repeatedly, over short and long periods of time. With the mobile communication devices' increased functionality, users may spend more time navigating menus and lists stored in their menu driven mobile communication devices. Some mobile users consolidate all of their communication routing such as telephone, email, SMS, banking, ticketing and Internet browsing usage to only their mobile telephone. Accordingly, some communication may be stored in lists of outgoing communication and incoming communication.

When placing a telephone call, for example, a user will scroll through the contact list stored in the memory of the mobile communication device. The contact information for a particular contact such as one or more telephone numbers, emails and/or website addresses may be stored together under one contact list entry. For users who communicate with the same persons or entities repeatedly, over short and long periods of time, they must scroll through the entire contact list for particular entries in the stored contact list. A speed dialing list from the stored contact list may be selected by a user, but must be updated manually by a user as frequently called contacts change.

### SUMMARY

Disclosed are methods and mobile communication devices for providing a history of communications with a contact according to at least one of a plurality of communication types. The communication types can include, for example, outgoing and incoming telephone calls, messaging service messages, voicemail box messages, and other communication types. A disclosed method can include storing a contact list in memory, the contact list including a plurality of contacts, each of the plurality of contacts including a contact identifier and routing information. Moreover, a method can include receiving a communication of a communication type of a plurality of communication types from a contact of the plurality of contacts. Furthermore, a disclosed method can include recording an indicator of the communication in a history of communications associated in the contact list with the contact of the contact list according to the communication type and displaying the history of communications with the contact according to at least one of the plurality of communication types.

An indicator of the communication with a contact according to the communication type can provide, for example, sorting criteria. A sorting criterion, such as a contact identifier, routing information, and time, date, duration, or length of communication, can provide a history of communications with the contact that can be displayed according to a communication type. A sorting criterion may be used in generating a particular contact group based, for example of frequency of communication. Thus, a particular contact group of contacts based on a frequency of communication or other criterion with the contacts can be displayed. In this way, different types of abridged contact lists can be generated and displayed.

It may be beneficial to help limit the amount of time users spend navigating menus and lists stored in their mobile communication devices, particularly in light of future increased functionality of menu driven mobile communication devices. For users who communicate with the same persons or entities repeatedly, over short and long periods of time, it may be beneficial if users were not required to scroll through the contact list for particular entries in the stored contact list, or maintain a speed call list manually.

### BRIEF DESCRIPTION OF THE DRAWINGS

FIG. 1 depicts an exemplary mobile communication device having a contact list stored in memory configured to include a plurality of communication types;

FIG. 2 depicts an example of the manner in which recording an indicator of the communication in a history of communications associated in the contact list with the contact of the contact list according to the communication type may provide sorting criteria;

FIG. 3 illustrates an exemplary display with an indicator prompt and an abridged contact list that can include a particular contact list;

FIG. 4 depicts an exemplary display showing a communication history of the messages of a particular contact including one or more indicators; and

FIG. 5 is an exemplary flowchart illustrating an embodiment of a process for providing a history of communications with the contact according to at least one of the plurality of communication types and abridged contact list of particular contacts.

### DETAILED DESCRIPTION

Before describing in detail embodiments that are in accordance with the present disclosure, it should be observed that the embodiments reside primarily in combinations of method steps and components related to providing a history of communications with a contact according to at least one of a plurality of communication types. Accordingly, the components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, up and down, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions of providing a history of communications with a contact according to at least one of a plurality of communication types, as described herein.

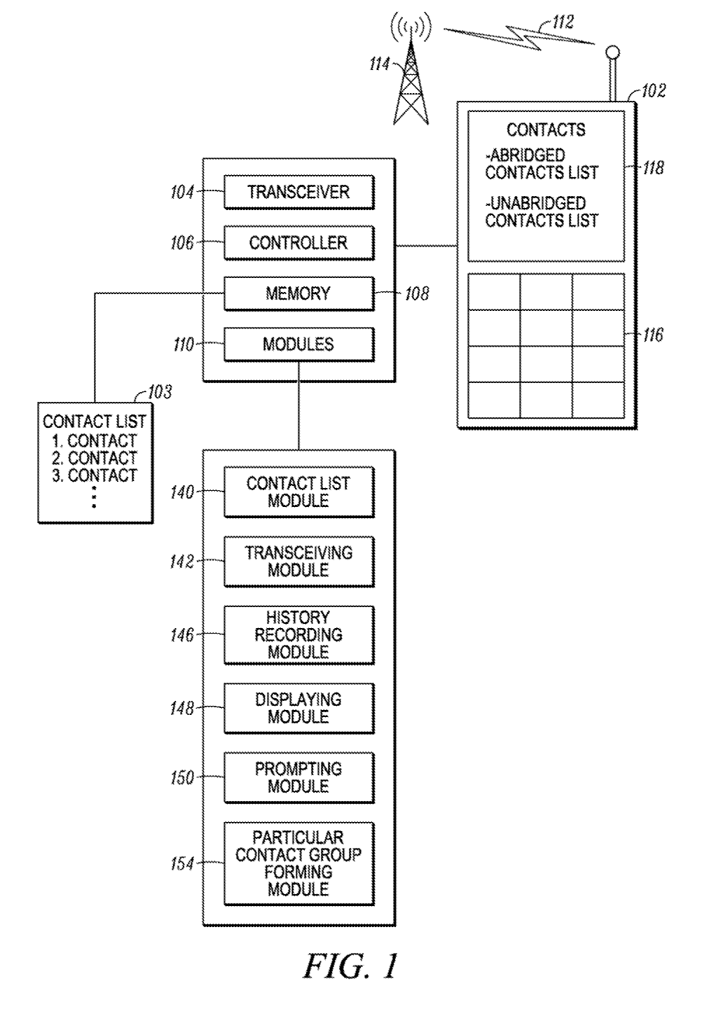

FIG. 1 depicts a mobile communication device 102 having a contact list 103 stored in memory configured to include a plurality of communication types. The mobile communication device 102 can include a transceiver 104, a controller 106, a memory 108 and modules 110. The memory 108 can be configured to store instructions of modules 110 and to store a contact list 103, the contact list including a plurality of contacts. The controller 106 can be coupled to the memory 108, the controller configured to process instructions of modules 110 stored in the memory 108 of the mobile communication device 102. The transceiver 104 may be coupled to the controller 106 and configured to receive a communication 112 of any type, for example, from a base station 114 or another mobile communication device in, for example, peer to peer communication. The communication 112 can be of a communication type of a plurality of communication types from a contact of the plurality of contacts stored in the contact list 103. The keypad 116 can direct user input to the device 102 and the display 118 can show output from various operations of the mobile communication device 102.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The modules 110 may carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

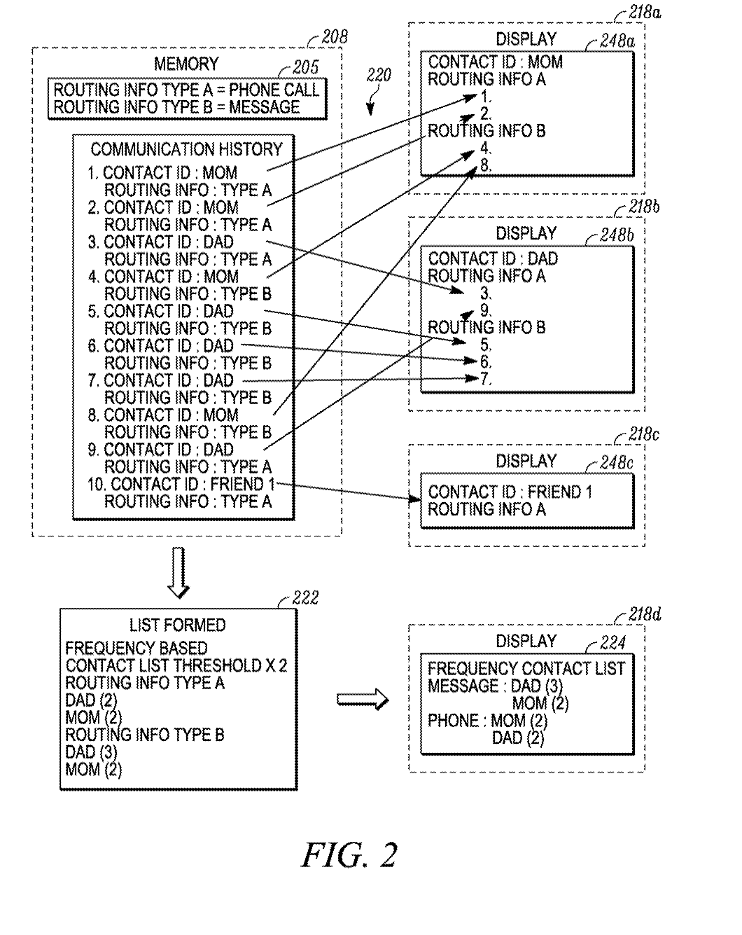

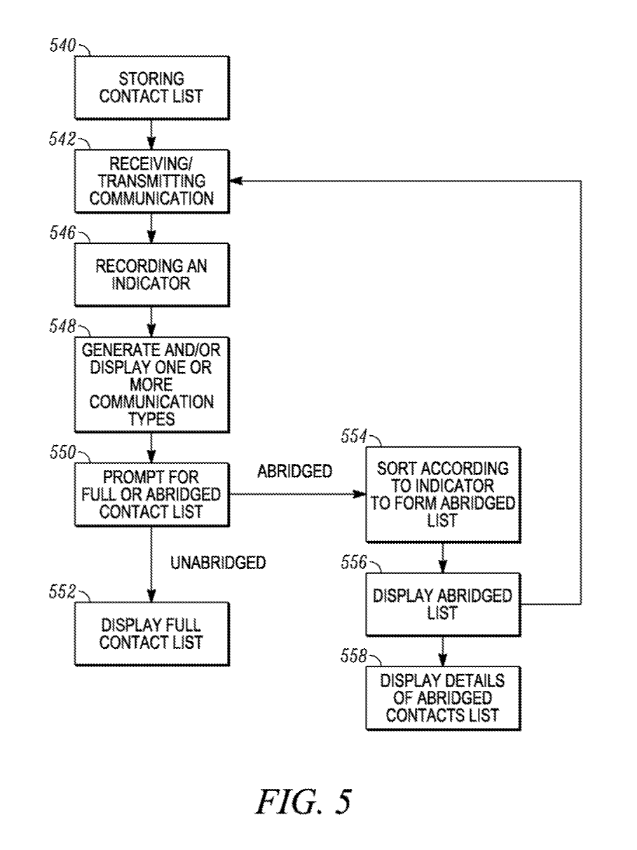

A contact list module 140 may include instructions for storing information related to receiving and transmitting communication 112 from a contact of the plurality of contacts of the contact list 103. A transceiving module 142 may include instructions for receiving and transmitting 542 (see FIG. 5) a communication of a communication type of a plurality of communication types from a contact of the plurality of contacts 103. A history recording module 146 may include instructions configured to record an indicator of a communication 112 in a history of communications 246 (see FIG. 2) with a contact of the contact list 103 according to at least one of the plurality of communication types. A displaying module 148 may include instructions configured to display the history of communications with the contact including displaying 430 (see FIG. 4) a time of a communication, displaying a date of the communication, displaying the duration or length of the communication and displaying a total number of communications with the contact of a particular communication type. The prompting module 150 may include instructions configured to prompt a user 550 (see FIG. 5) to choose between the particular contact group and a different contact list such as an unabridged contact list. The particular contact group forming module 154 may include instructions configured to form from the contact list 103, an abridged contact list 224 (see FIG. 2) of a particular contact group of contacts based on a frequency or one or more other indicators or criteria of communication with the contacts.

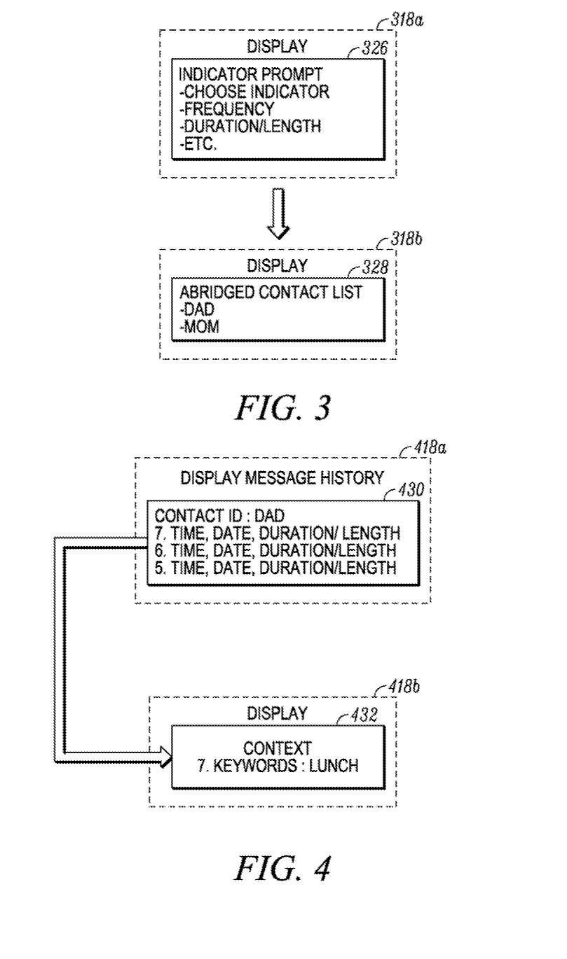

FIG. 2 depicts an example of the manner in which recording an indicator of the communication in a history of communications associated in the contact list 103 (see FIG. 1) with the contact of the contact list according to the communication type may provide sorting criteria to generate an abridged contact list 328 (see FIG. 3). In memory 208, indicators such a contact identifier and routing information may be stored. Routing information may, for example, include one selected from the group of an e-mail address, a telephone number, a website address or a mobile-to-mobile communication channel data. In the example of FIG. 2, routing information of type A may be a telephone number and routing information of type B may be a message address.

The communication history 246 is illustrated by a sequence of communications that can include contact identifiers and routing information 205 that can be stored in memory 208. In this example, the history 246 includes telephone calls and messages combined. For example, the telephone calls and the messages may be sequential in time. The history 246 alternatively may be broken into various components according to indicators, such as routing information, where telephone calls from telephone numbers are listed together, messages such as short messaging services (SMS) and/or multimedia messaging services (MMS), and voice mail messages are listed together or separate and/or website access are listed together, either by outgoing or incoming communication. Certain types of messages are routed from telephone numbers, such as SMS messages. Other types of messages such as email are routed from an Internet address. In the depiction of FIG. 2 the sequence from one to ten of telephone calls and messages is shown for illustrative purposes.

The contact identifier 205 may be retrieved from information stored in a contact list 103 (see FIG. 1). The contact list 103 may be generated in any manner. For example, the contact list 103 may be manually input by the user, for example via the keypad 116 (see FIG. 1), voice recognition or downloaded from another source. The contact list 103 can also be populated automatically by accepting information from incoming calls or otherwise. The contact identifier of the first entry in the communication history 246 is “Mom,” as are those of the 2^{nd}, 4^{th} and 8^{th} entries. The contact identifier in the communication history 246 is “Dad” for entries numbered 3, 5, 6 and 7. For the Mom, Dad, and “Friend 1” entries, indicators such as the contact identifier and the routing information 205 that is either a telephone call or a message in this example may have been recorded. To display the history of communications 246 with the contact according to at least one of the plurality of communication types, the entries of the communication history 246 may be sorted according to the indicators 205 or other criteria such as that previously described.

The arrows 220 from the communication history 246 to the displays 218a, 218b, and 218c indicate the mapping of entries. Accordingly, the displays 218a, 218b, and 218c can show the history of communications 248a, 248b, and 248c with the contact according to at least one of the plurality of communication types. In this case the first display 218a provides indicia for the contact identifier, here, Mom, and the communication history 248a for routing information A and B. The second display 218b provides indicia for the contact identifier, here, Dad, and the communication history 248b for routing information A and B. The third display 218c provides indicia for the contact identifier, here, Friend 1, and the communication history 248c for routing information A.

The particular contact group forming module 154 (see FIG. 1) can be configured to form from the contact list 103, a particular contact group of contacts 222. A frequency of communication with the contacts may be the basis for forming the list 222. The frequency based contact list threshold, for example may be two contacts of a particular communication type. The displayed list 224 on display 218d may list the contact identifiers or some other indicia. In that case, the frequency list may show Mom and Dad since their communication, incoming and/or outgoing, equals or exceeds the threshold. In the event that the routing information is displayed on display 218d, routing information type A may show Mom (2) and Dad (2) and routing information type B may show Dad (3) and Mom (2). Since there was lower frequency than a frequency threshold value set at two for illustrative purposes for Friend 1, Friend 1 may not be included in the frequency list formed 222. The frequency threshold value may be instituted in any manner. It is understood, that the abridged contact list 224 of particular contacts may be based on other criteria than frequency, such as context of communication, routing information, time and/or date of communication.

On the display 218d may be a frequency contact list 224 including those contacts that equal or exceed the frequency threshold value for communications that may span any particular time period. The frequency threshold value, set at a particular number either by default or by user preference, can sort out a particular contact group of contacts based on a frequency of communication with the contacts. The frequency contact list 224 may include any type of information such as the routing information, or it may include more or less information. The list can display the contact identifier or other indicia. It is illustrated that display 218d can display the particular contact group plus routing information, in this case Dad with 3 messages, Mom with 2 messages, Mom with 2 phone calls and Dad with 2 phone calls based upon frequency or another criterion. Another criterion or indicator can include, for example, keyword, duration, length, or any suitable criterion.

FIG. 3 illustrates a display 318 with an indicator prompt 326 and an abridged contact list 328, that is, a contact list based upon one or more criteria that may help limit the amount of time users spend navigating menus and lists stored in their mobile communication devices 102 (see FIG. 1). The abridged contact list 328 of display 318a of particular contacts can be a processed contact list that may provide information to limit an amount of time a user may spend navigating through one or more lists on the display screen 118 (see FIG. 1). For users who communicate with the same persons, contacts or entities repeatedly, over short and long periods of time, the abridged contact list 328 of display 318b can help users access contact information of particular entries in their contact list 103 without scrolling through one or more unprocessed lists for particular entries in the stored contact list, or maintaining a speed call list manually. For example, in an embodiment the abridged contact list can be called up by a programmed or soft key.

As previously discussed, recording an indicator of the communication in a history 246 (see FIG. 2) of communications associated in the contact list 103 (see FIG. 1) so that the sorting may be according to criterion or criteria can include recording a contact identifier, routing number, time, date, duration or length of communication, or any other indicator set by user preference or by default. On list 326 of display 318a, a prompt for an indicator for the abridged contact list of particular contacts may be displayed so that a communication history 246 may be sorted according to an indicator. In the example of FIG. 3, the abridged contact list 328 of display 318b may be generated according to an indicator such as frequency of communication. The alternatives for generating abridged contact lists may include sorting by indicators such as duration/length, time period, and routing such as by telephone or messages, or context of the communication as will described below.

An abridged contact list 328 of particular contacts sorted according to frequency where two communications is a threshold value, may include Dad and Mom. As mentioned above, the abridged contact list 328 can be a dynamic list. As the communication history changes, or as user preferences change, the abridged contact list 328 may change. For example, a contact from the particular contact group or the abridged contact list may be not included or may be removed when the frequency of communication is below a predetermined frequency threshold for example during a particular period of time. When accessing one or more of the contacts listed in the abridged contact list 328, the communication history of the contact may be expanded so that one or more indicators are presented in a screen display.

FIG. 4 depicts a display 418a showing a communication history of the messages of a particular contact, Dad, including one or more indicators. A contact identifier, Dad, and the routing information such as messages may be indicated. In this example, the most recent communication is listed first, such being item 7. The items in this example are listed in descending order, 7, 6 and 5. A prompt may be provided to display the context of a listed communication. The context screen 432 may be accessed on the same screen as the abridged contact list 328 (see FIG. 3) or at any other display opportunity.

The context of a communication such as a message may be evaluated manually or by automatic processes. Manual input may be prompted by the mobile communication device at any time during or after the communication. A user can provide context, orally or through the keypad 116 (see FIG. 1) so that at a later time the user can access the user provided context. Additionally or alternatively, the device may utilize voice recognition capability or in the example of text messages such as SMS or email, keyword searches. The context screen 432 of display 418b illustrates that the most recent communication, item 7, from Dad includes a reference to lunch. The context of the message communication type or any other communication type may provide the user with the ability to maintain communication with contacts.

FIG. 5 is a flowchart 500 illustrating an embodiment of a process for providing the above-described history of communications 246 (see FIG. 2) with the contact according to at least one of the plurality of communication types and abridged contact list 328 (see FIG. 3) of particular contacts. As mentioned above, one or more contact lists 103 (see FIG. 1) may be populated in any manner and stored 540. A contact list 103 in memory 108 can include a plurality of contacts, each of the plurality of contacts including a contact identifier and routing information. A contact list module 140 (see FIG. 1) may include instructions for storing information related to receiving and transmitting communication from a contact of the plurality of contacts of a contact list. Receiving a communication 542 of a communication type of a plurality of communication types from a contact of the plurality of contacts can be provided by a transceiving module 142 that may include instructions for receiving and transmitting a communication of a communication type of a plurality of communication types from a contact of the plurality of contacts. Recording an indicator of the communication 546 in a history of communications 246 according to the communication type may be provided by a history recording module 146 that may include instructions configured to record an indicator of a communication according to at least one of the plurality of communication types. Displaying the history 548 of communications with the contact according to at least one of the plurality of communication types may be provided by a displaying module 148 that may include instructions configured to display the history of communications 246 with the contact. Displaying may include displaying a time of a communication, displaying a date of the communication, displaying the duration or length of the communication, displaying a keyword of the communication, and displaying a total number of communications with the contact of a particular communication type.

Receiving a response to prompting the user 550, in particular as to whether to show an abridged contact list or an unabridged contact list, may call up a sorted list, or activate sorting. The prompting module 150 may include instructions configured to prompt a user to choose between the particular contact group and the contact list. In the event the user chooses, either in response to the prompt, or in another manner, to display an unabridged contact list, that is, one not sorted as described above, it may be displayed 552.

The user may choose to access or generate a list of a particular contact group 554 as described in detail above. Particular contact group forming module 154 (see FIG. 1) may include instructions configured to form from the contact list, a particular contact group of contacts based on a frequency of communication with the contacts. The abridged list may be displayed 556. In the meantime, further communication 112 may take place. Therefore the loop back to the receiving or transmitting communication 542 may provide more information to the communication history 246 (see FIG. 2). In this way, an abridged list 328 (see FIG. 3) may be a dynamic list, changing with, for example, additional communication information as well as according to different indicators. As discussed above, details of the abridged contact list 328 may be provided 558 (see 430 and 432 of FIG. 4).

The history of communications with the contact according to at least one of the plurality of communication types may be beneficial to help limit the amount of time users spend navigating menus and lists stored in their mobile communication devices. Additionally, the abridged contact list of particular contact may be beneficial to help limit the amount of time users spend navigating menus and lists. For users who communicate with the same persons or entities repeatedly, over short and long periods of time, it would be beneficial if users were not required to scroll through the contact list for particular entries in the stored contact list, or maintain a speed call list manually.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the disclosure as determined by the appended claims, as may be amended during the pendency of this application for patent, and all equivalents thereof, when interpreted in accordance with the breadth to which they are fairly, legally and equitably enMETHODS AND DEVICES FOR ABRIDGED CONTACT LIST CREATION BASED ON COMMUNICATION HISTORYd.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method of a mobile communication device, comprising:
storing a contact list in memory, the contact list including a plurality of contacts, each of the plurality of contacts including a contact identifier and routing information;
receiving a communication of a communication type of a plurality of communication types from a contact of the plurality of contacts;
recording an indicator of the communication in a history of communications associated in the contact list with the contact of the contact list according to the communication type; and
displaying the history of communications with the contact according to at least one of the plurality of communication types.

2. The method according to claim 1, wherein the routing information includes one selected from the group of an e-mail address and a telephone number.

3. The method of claim 1 further comprising:
forming from the contact list, a particular contact group of contacts based on a frequency of communication with the contacts; and
displaying the particular contact group.

4. The method of claim 1, wherein displaying the history of communication with the contact comprises:
displaying a most recent communication with the contact according to at least one of the plurality of communication types.

5. The method of claim 1 wherein displaying the history of communication with the contact comprises:
displaying a time of a communication;
displaying a date of the communication;
displaying a duration of the communication; and
displaying a total number of communications with the contact of a particular communication type.

6. The method of claim 1 wherein displaying the history with the contact comprises:
displaying one selected from the group of a content and context of the communication.

7. The method of claim 1 wherein the communication types comprise outgoing and incoming telephone calls.

8. The method of claim 1 wherein the communication types comprise outgoing and incoming messages selected from the group of SMS, MMS and email.

9. The method of claim 1 wherein the communication types comprise outgoing and incoming voicemail box messages.

10. A method of a mobile communication device, the method comprising:
storing a contact list in memory, the contact list including a plurality of contacts, each of the plurality of contacts including a contact identifier;
receiving a communication of a communication type of a plurality of communication types from a contact of the plurality of contacts;
recording an indicator of the communication in a history of communications associated in the contact list with the contact of the contact list according to the communication type;
receiving an input to display displaying at least a portion of plurality of contacts of the contact list;
displaying at least a portion of plurality of contacts of the contact list;
while displaying at least a portion of the plurality of contacts, providing an option to display history of communications with respect to one contact;
receiving an input to display history of communications with respect to the one contact; and
displaying the history of communications with the one contact according to at least one of the plurality of communication types, in response to receiving the input.

11. The method of claim 10 further comprising:
forming from the contact list, a particular contact group of contacts based on a frequency of communication with the contacts; and
displaying the particular contact group.

12. The method of claim 11 wherein the frequency exceeds a predetermined frequency threshold.

13. The method of claim 11 further comprising:
removing a contact from the particular contact group when the frequency of communication is below a predetermined frequency threshold.

14. A method of claim 11 wherein displaying the particular contact group comprises:
prompting a user to choose between the particular contact group and the contact list.

15. The method of claim 11, further comprising:
recording an indicator of the communication in a history of communications associated in the contact list with the contact of the contact list according to the communication type; and
displaying the history of communication with the contact according to at least one of the plurality of communication types.

16. The method of claim 15 wherein displaying the history of communication with the contact comprises:
displaying a most recent communication with the contact according to at least one of the plurality of communication types.

17. The method of claim 15 wherein displaying the history of communication with the contact comprises:
displaying a time of a communication;
displaying a date of the communication;
displaying a duration of the communication; and
displaying a total number of communications with the contact of a particular communication type.

18. The method of claim 15 wherein displaying the history of communication with the contact comprises:
displaying one selected from the group of a content and a context of the communication.

19. A mobile communication device having a contact list stored in memory configured to include a plurality of communication types, comprising:
a memory configured to store instructions of modules and to store a contact list, the contact list including a plurality of contacts;
a controller coupled to the memory, the controller configured to process instructions of modules stored in the memory of the mobile communication device;
a transceiver coupled to the controller and configured to receive a communication of a communication type of a plurality of communication types from a contact of the plurality of contacts; and
a history recording module configured to record an indicator of a communication in a history of communications with a contact of the contact list according to at least one of the plurality of communication types.

20. The device of claim 19 further comprising:
a displaying module configured to display the history of communications with the contact including:
displaying a time of a communication;
displaying a date of the communication;
displaying a duration of the communication; and
displaying a total number of communications with the contact of a particular communication type.

21. The device of claim 19, further comprising:
a particular contact group forming module configured to form from the contact list, a particular contact group of contacts based on a frequency of communication with the contacts.

22. The device of claim 19 further comprising:
a prompting module configured to prompt a user to choose between the particular contact group and the contact list.
